(19) United States
(12) Patent Application Publication
(10) Pub. No.: US 2012/0180466 A1
(43) Pub. Date: Jul. 19, 2012

(54) Switch and Control Device and Drive Train for a Hydrodynamic Machine

(76) Inventor: Markus Bischoff, Gaildorf-Ottendorf (DE)

(21) Appl. No.: 13/388,383

(22) PCT Filed: Oct. 1, 2010
(86) PCT No.: PCT/EP2010/006017

§ 371 Date: Apr. 2, 2012

(30) Foreign Application Priority Data
Oct. 23, 2009 (DE) 102009050512.1

(51) Int. Cl. F16D 33/02

(52) U.S. Cl. 60/347

(57) ABSTRACT

The invention relates to a switch and control device for setting the power or torque transmission in a hydrodynamic machine, comprising at least one primary wheel and a secondary wheel, which together form a working space that can be filled with a working medium—comprising a housing that is composed of a main body and two shells; at least one electronic component that is at least indirectly used for controlling and/or monitoring the hydrodynamic machine or a predetermined state of said machine; at least one control valve that can be actuated by means of the electronic component in order to control a working medium flow in the hydrodynamic machine or into or out of the hydrodynamic machine.

The invention is characterized in that: the first shell encloses the electronic component; the second shell receives at least a portion of the at least one control valve; the two shells are arranged on end faces of the main body that face away from each other; the first shell and/or the main body are arranged on the hydrodynamic machine or on a line conducting the working medium flow into or out of the hydrodynamic machine such that heat transfer takes place between the working medium and/or the hydrodynamic machine on the one hand and the electronic component on the other hand.

The present invention relates to a switch and control device for setting the power or torque transmission in a hydrodynamic machine and a drive train with a hydrodynamic machine.

Switch and control devices and drive trains, especially drive trains for motor vehicles, with or for the control of hydrodynamic machines are known. Hydrodynamic brakes (retarders) are used for the wear-free breaking of a vehicle such as a truck for example.

Such hydrodynamic machines comprise a working space which can be filled with working medium or discharged from the same in order to transmit drive power or, especially in the case of a retarder, torque in a wear-free manner from a primary wheel to a secondary wheel of the hydrodynamic machine, from the rotor to the stator or in a configuration as a retarder or a counter-running rotor of the retarder. Depending on the desired transmission of torque and power, a specific quantity of working medium which characterizes the degree of filling is held in the working space of the hydrodynamic machine, wherein usually only the quantity of working medium present in the working space will be kept constant depending on the desired power, while an exchange of the working medium is performed for the cooling of the same. The guidance of the working medium in the hydrodynamic machine, out of the same and/or within the hydrodynamic machine is controlled by at least one control valve or a plurality thereof.

The introduction of preferably fluid working medium into the hydrodynamic machine or out of the same can be controlled by switching or adjusting control members in the (external) working medium circuit. The adjustment of these control members in the working medium circuit can occur by pressurization of the valves with compressed air. The level of the pneumatic pressure on the other hand can be controlled or adjusted by means of control valves which are arranged in an external compressed-air system, so that the desired working medium flow into the working space of the hydrodynamic machine and out of the same is obtained and the degree of filling of the working space with working medium which leads to a respective power transmission can be controlled thereby. The air of the compressed-air system therefore controls the control or shut-off valves and/or slides and/or flaps in the working medium circuit of the hydrodynamic machine, e.g. an inlet and/or outlet valve for the hydrodynamic machine, with the mentioned working medium circuit usually extending outside of the hydrodynamic machine. Air or any other control medium consequently flows through the control valves, in contrast to the valves, slides or flaps in the working medium circuit which are switched by the control air.

The at least one control valve can be arranged as a solenoid valve for example and can be actuated by at least one switch and control device associated with said valve. This can occur for example by applying a voltage to the magnetic coil of the respective solenoid valve.

The switch and control device comprises electronic components which are subject to heating in power operation. This is due to the fact that the current-carrying electric components will generate exhaust heat themselves by their operation and are additionally frequently subjected to a high-temperature ambient environment as a result of their installation position (mostly in the engine compartment or in the drive train). Ambient temperatures of more than 100° C. are reached for example in the engine compartment of a motor vehicle for example. Such high temperatures will have a negative effect on the stability and the life of the electric and electronic components. In order to ensure stability even at higher temperatures and to prevent malfunctions of the units (such as retarders for example) which are controlled by the switch devices, methods have been proposed recently in order to reduce the activation periods of the switch and control devices and the units which are switched by such devices. Self-heating is thereby reduced, so that the maximum permissible temperature of the materials of the electronic components can be observed. Another possibility to ensure secure application in high-temperature environments is to arrange the materials of the switch and control devices in such a way that they are resistant to high temperatures. This comes with the disadvantage however that generally the economic and production expenditure caused by the expensive material will be increased.

The specification DE 10 2005 037 640 A1 which is laid open for public inspection therefore proposes in a hydrodynamic machine to arrange the control device that actuates the control valves in or on the coolant circuit in such a way that heat from the control device is dissipated by way of the cooling medium circuit by having the coolant flow against or around said device. Preferably, the flow also flows against or around the control valve, so that its heat is also absorbed by the cooling medium and is dissipated by way of the cooling medium circuit which is simultaneously also the working medium circuit of the hydrodynamic machine. The control device and the control valve can be integrated in a common control module and can be enclosed by a common housing.

Although a more cost-effective choice of materials is possible by the mentioned state of the art, there is room for further improvements in setting a suitable temperature in the control device which should be as constant as possible. Especially the simultaneous cooling of the control device in the control valve by the working medium has proven to be relatively complex and has been seen to be far from optimal with respect to the temperature of the electronics in the control device.

Reference is hereby made to the following documents concerning the further published state of the art:
WO 02/35 898 A1
DE 43 10 891 C1
EP 1 053 923 B1
DE 10 2004 034 734 A1
DE 197 10 931 A1

They show switch and control devices with a constructional combination of control component and cooling ducts within a housing.

The present invention is based on the object of providing a switch and control device for setting the power or torque transmission in a hydrodynamic machine which is improved with respect to the temperature obtained in operation in an electronic system contained therein which is used for controlling and/or monitoring the hydrodynamic machine or a predetermined state in the same. In particular, high stability in the control of the hydrodynamic machine shall be ensured at relatively high ambient temperatures by using inexpensive and simple materials with high availability and long service life. Furthermore, a drive train of a hydrodynamic machine will be provided which comprises a switch and control device in accordance with the invention.

The object in accordance with the invention is achieved by a switch and control device according to claim 1 and a drive train according to claim 10. The dependent claims describe advantageous and especially appropriate embodiments of the invention.

A switch and control device for setting the power or torque transmission in a hydrodynamic machine which comprises at least one primary wheel and a secondary wheel which together form a working space that can be filled with a working medium comprises a housing that is composed of a main body and two shells and at least one electronic component (also known as control electronics or retarder ECU) that is used at least indirectly for controlling and/or monitoring the hydrodynamic machine or a predetermined state of said machine. Furthermore, at least one control valve is provided which can be actuated by the electronic component in order to control a working medium flow in the hydrodynamic machine or into or out of the hydrodynamic machine. The at least one control valve can be actuated by means of the electronic component in such a way for example that it provides an actuating pressure, especially in the form of an air pressure, by means of which at least one control valve or regulating valve disposed in the working medium circuit of the hydrodynamic machine is pressurized in order to control or adjust the power transmission with the hydrodynamic machine. Alternatively, the actuating pressure can also be applied to the working medium, especially the stored working medium, in such a way that this pressurization presses more or less working medium into the working space of the hydrodynamic machine in order to set the level of filling of the working space as required. Especially in the first case, water or water mixture which is simultaneously the cooling medium of the cooling circuit can be used as a working medium. In the second case as mentioned above, oil can be used as the working medium for example which is advantageously cooled by way of a separate cooling circuit.

In accordance with the invention, the first shell encloses the electronic module, whereas the second shell accommodates at least a part of the at least one control valve. Both shells are arranged on face sides of the base body which face away from one another, wherein the first shell and/or the base body is/are arranged on the hydrodynamic machine or on a conduit guiding the working medium flow into or out of the hydrodynamic machine, so that there is heat transmission between the working medium and/or the hydrodynamic machine on the one hand and the electronic component on the other hand.

As a result of this convenient arrangement of the switch and control device on the hydrodynamic machine or on a working-medium-carrying conduit leading especially from or to the same, it is achieved that the electronic component is actively cooled by the working medium of the hydrodynamic machine when the working medium has a lower temperature than the ambient temperature. At the same time, the control element is thermally decoupled from the electronic component in such a way that its heat will not lead to an additional heating of the electronic component or only to a desired heating for purposeful tempering in permanent operation, despite the fact that both components are positioned relatively close to one another in a common housing.

The first shell advantageously faces away from the second shell and ambient air flows around the second shell in such a way that heat from the control valve is convectively dissipated to the ambient environment. Convection can occur naturally or be caused by forced circulation of the ambient air. In order to increase the heat-emitting surface, the second shell can form cooling ribs for example on its exterior surface facing the ambient environment in order to increase cooling output. The electronic component is substantially decoupled from ambient heat by separating the part of the housing containing the control valves from the part of the housing enclosing the electronic component. This ensures improved stability and increase service life of the electronic component and thus the entire switch and control device. Furthermore, the control device can also be installed at a location with higher ambient temperature as a result of active cooling than would be possible without active cooling, so that the available installation space can be used optimally. This obviously requires a respective cooling output of the working medium which flows through the hydrodynamic machine.

The first shell and/or the base body are advantageously arranged to be thermally conductive with respect to one another and/or with respect to the hydrodynamic machine or the working-medium-carrying conduit.

It would also be possible to arrange this connection in a thermally insulated manner, so that only a relatively low thermal flow is permitted between these components.

The interior spaces of the two shells or the interior spaces formed by the base body and the respective shell are thermally insulated against one another and/or sealed against one another in a pressure tight-manner. The thermal insulation substantially prevents the heat transfer which is generated in operation of the control valves by the magnetic coils into the electronic component, by means of which the efficiency of the cooling is increased. The pressure-tight sealing on the other hand prevents losses in the compressed-air circuit.

Although the at least one valve is designated in the switch and control device in accordance with the invention as a control valve, this term shall include any suitable valve which is capable of setting the power transmission with the hydrodynamic machine in an at least indirect manner or of monitoring a state in the hydrodynamic machine. For example, the at least one control valve can be arranged as a switching valve, directional control valve or electro-pneumatic actuator. Among other things, a purely electrical control valve can be considered in addition to an electromagnetically actuated control valve, the electric drive of which can be cooled in accordance with one embodiment by the working medium of the hydrodynamic machine if it is positioned accordingly on the first shell and/or the base body. Valves other than control valves can also be considered.

The housing and the first shell for example are preferably mounted on the hydrodynamic machine or on the conduit in such a way that the housing or the first shell is insulated against vibrations of the hydrodynamic machine or the respective line. As a result, damage to the electronic component by mechanical influences from the outside (e.g. jolts) is especially reduced.

Advantageously the housing and the base body for example comprise connections for electric lines which are connected in an electrically conductive manner with at least one or a plurality of control valves and/or the electronic component.

The housing and especially the base body advantageously comprise at least one connection for a compressed-air conduit which is connected with the at least one control valve in a manner conducting the compressed air. For example, a first connection is provided for a compressed-air supply and a second connection for an actuating pressure, which are each connected with at least one control valve in a manner conducting the compressed air, so that a desired actuating air pressure for setting the power transmission in the hydrodynamic machine can be provided by means of the control valve in that the control valve releases to a higher or lower extent the flow cross section for compressed air from the compressed-air supply. It is obviously also possible to use another pressure-conducting medium instead of compressed air.

In accordance with one embodiment, it is also possible to provide several actuating pressure connections, the pressure of which can be controlled or adjusted jointly by one control device or separately by various control devices.

In accordance with an advantageous embodiment, the housing comprises a venting or exhaust air connection especially in addition to the connection for the supply with pressure or compressed air and the at least one connection for the actuating pressure, by way of which the at least one control valve and especially the remaining air-conducting spaces can be evacuated when the compressed-air supply is separated by means of a respective shut-off member, which is especially also disposed in the interior of the housing. The shut-off member can be arranged as a control valve again which is advantageously arranged in the space formed by the second shell and the base body, with the term of control valve being understood to be any suitable valve such as a directional control slide valve, switching valve or generally an actuator, especially an electropneumatic or electric actuator, which is suitable to optionally produce the disconnection of the compressed-air supply. The statements made above apply concerning the choice of the medium, which means that not only compressed air can be used as a control medium but also any other suitable medium such as a fluid.

Preferably, the housing and especially the base body comprise at least one connection for a pressure conduit, especially a compressed-air conduit, which is connected with a pressure sensor in a pressure-conducting manner which is arranged on the electronic component or in the interior space formed by the base body and the second shell and is arranged in a pressure-tight manner in relation to the interior space for example. An external pressure can thereby be supplied to this connection which will be detected by the pressure sensor and will be evaluated especially by the electronic component or will be provided as a parameter.

In accordance with a further embodiment, a drive train is provided with a hydrodynamic machine, comprising at least one primary wheel and a secondary wheel which jointly form a working space which can be filled with a working medium. Furthermore, a cooling-medium circuit with a fluid or gaseous cooling medium is provided in order to cool the hydrodynamic machine and/or the working medium of the same in an at least indirect manner. The hydrodynamic machine can also be arranged directly in the cooling-medium circuit and the working medium can simultaneously be the cooling medium. In accordance with the invention, a control unit according to one of the claims 1 to 10 is provided for setting the transmission of power or torque in the hydrodynamic machine.

The invention will now be explained in closer detail by reference to embodiments and the enclosed drawings by way of example, wherein:

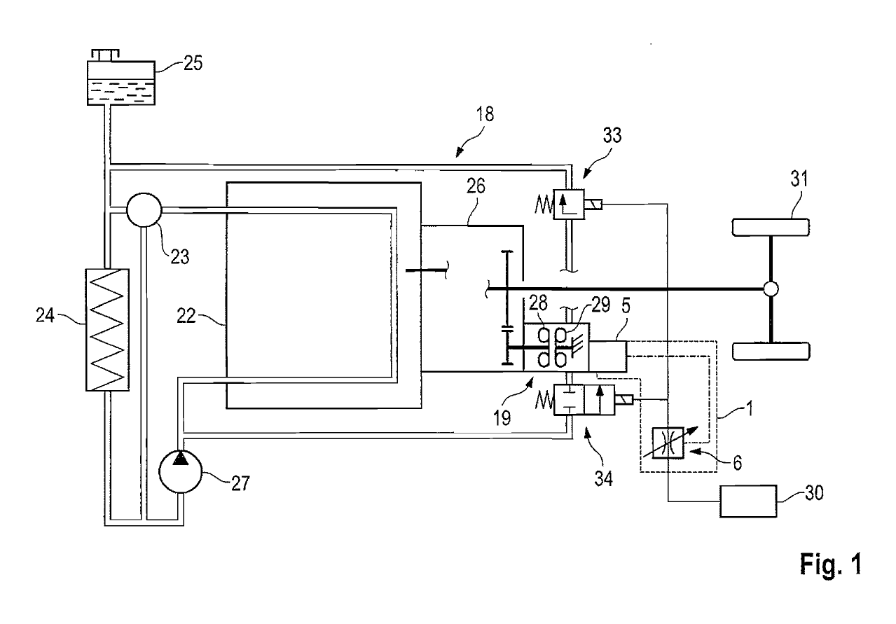

FIG. 1 shows a schematic illustration of a drive train according to an advantageous embodiment;

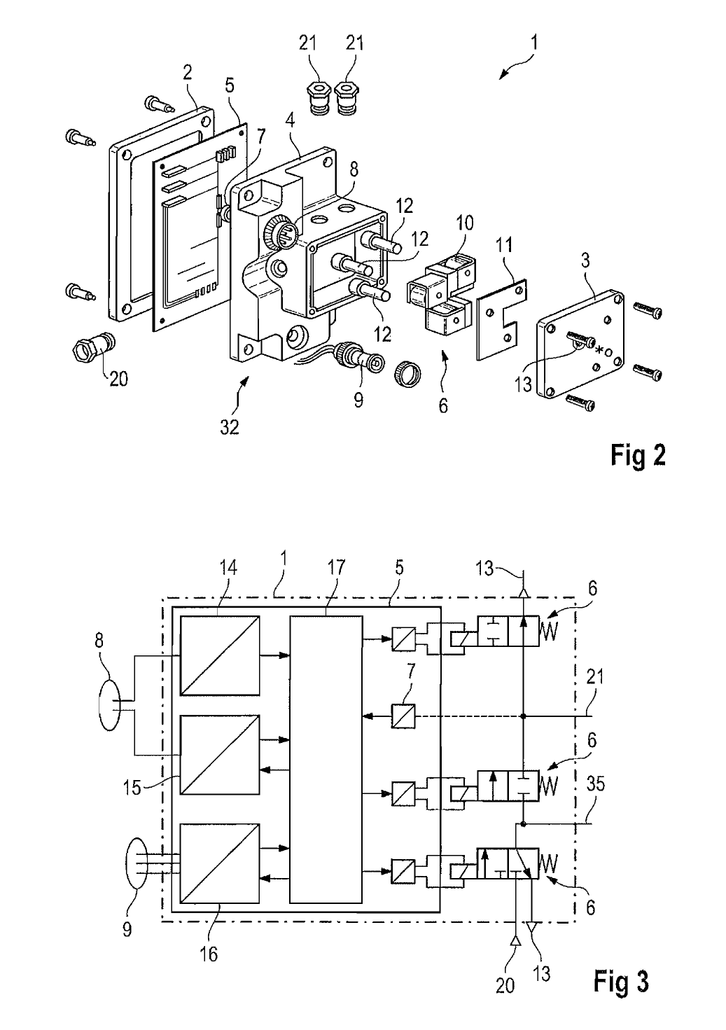

FIG. 2 shows an exploded view of a switch and control device in accordance with the invention;

FIG. 3 shows a schematic illustration of a switch and control device in accordance with the invention.

FIG. 1 shows a schematic illustration of a drive train of a motor vehicle. It comprises a cooling medium circuit 18. A vehicle drive motor 22, a thermostat 23 and a heat exchanger 24 are switched behind one another as seen in the direction of flow of the cooling medium. Furthermore, a compensating reservoir is provided for the working medium 25. A hydrodynamic machine 19 which is arranged in this case as a hydrodynamic retarder is switched in this case in the cooling medium circuit parallel to the vehicle drive motor 22, the working medium of which is simultaneously the cooling medium. The cooling medium can be water or water mixture. The following components are arranged in the cooling medium circuit 18 behind the retarder in the direction of flow: a retarder control valve 33, the orifice of the compensating reservoir 25, the heat exchanger 24, a circulating pump 27 and a retarder switching valve 34. The hydrodynamic retarder is arranged in this case as a secondary retarder, meaning that it is coupled to a transmission 26 or to its secondary side, especially directly to a power take-off shaft of the transmission 26, and retards the same in braking operation. Similarly, the hydrodynamic retarder could be in driving connection with a universal shaft, especially behind the transmission 26.

A configuration as a primary retarder would also be possible, with said primary retarder retarding the vehicle by circumventing the transmission 26 or by coupling to the primary side of the transmission 26, especially directly to the drive or crankshaft of the vehicle drive motor 22, which can be arranged as a diesel engine for example.

In order to set a predetermined working medium pressure in a working space of the hydrodynamic retarder formed by a primary wheel 28 and the secondary wheel 29, the flow cross section of at least one of the retarder valves 33, 34 is changed in order to control the degree of filling of the working space with working medium. In the present case, the control valve 33 and the switching valve 34 are triggered by a control valve 6 which is arranged as a pneumatic valve. For this purpose, compressed air is provided in a pneumatic pressure reservoir 30 or a compressed-air system (not shown).

As is shown in FIG. 1, the hydrodynamic retarder is associated with a power control, which in the present case is an electronic component 5, which triggers the control valve 6 connected in outgoing circuit with the pressure reservoir 30. The electronic component 5 and the control valve 6 are part of a switch and control device 1 in accordance with the invention which will be explained below in closer detail by reference to FIGS. 2 and 3. For example, a signal for initiating a braking process is supplied to the electronic component 5, especially by way of a connected CAN bus, by actuating a brake pedal or any other actuator such as a selector lever (not shown). The flow cross section for compressed air of the control pressure valve 6 which is connected in outgoing circuit with the pressure reservoir 30 is increased, so that compressed air from the compressed-air reservoir 30 or a compressed-air system will be supplied simultaneously with increasing pressure to the retarder valves 33, 34 arranged in the cooling medium circuit 18. In this case, especially the switching valve 34 which is connected upstream of the retarder will be switched to a pass-through position, so that working medium will reach the retarder from the cooling medium circuit 18 and the control valve 33 connected with the retarder in outgoing circuit is brought to a control position which leads to the setting of the desired braking torque. In order to achieve power control of the retarder in the lower power range with a very low working medium pressure in the working space of the retarder, the control valve 33 can also be fully opened at first in the direction of flow of the working medium behind the retarder and the switching valve 34 in the direction of flow before the retarder is switched into a partly open control position which leads to the setting of the desired braking torque. In the higher power range, the switching valve 34 is brought to the fully opened pass-through position and the control valve 33 assumes the control of the braking torque. The primary wheel 28, and in combination with the same the power take-off shaft or transmission output shaft, and finally the wheels 31 are retarded by the formation of a hydrodynamic circuit in the working space of the retarder between the primary wheel 28 in the secondary wheel 29.

FIG. 2 shows an exploded view of a switch and control device 1 in accordance with the invention. It comprises a first shell 2 which is shown in the present case as a prismatic planar plate. The shell 2 is connected at least indirectly with the retarder with its one face side. At least indirectly shall mean that it can be arranged by way of an interposed heat exchanger or any other component through which the working medium flows such as a conduit for example, and the former especially when the working medium of the retarder is not the cooling medium of the cooling circuit (deviating from the illustration in the drawing).

The switch and control device 1 further comprises a base body 4 and the second shell 3. The two shells 2, 3 jointly form a housing of the switch and control device 1 together with the base body 4 with two mutually separated inside spaces, with the two shells 2, 3 being arranged on two sides of the base body 4 facing away from each other and forming the face side of the housing 32.

An electronic component 5 is positioned in the first inside space which is formed by the shell 2 and the base body 4. The electronic component 5 comprises the electronic components which are necessary for the close-loop or open-loop control such as at least one controller or logic circuits for example.

Three control valves 6 are positioned in the second inside space which is formed between the second shell 3 and the base body 4, which control valves are accommodated by the base body 4 and optionally release or close the flow cross section for compressed air of a control-air system. The control valves 6 are arranged as electropneumatic actuators and accordingly comprise in the present case 3 valve bodies 12 and magnetic coils 10 which are associated with them and which enable a displacement of the valve bodies 12 by applying an electric voltage.

A retainer 11 is provided between the control valve 6 and the second shell 3, especially between the magnetic coils 10 and the shell 3, which retainer absorbs the movement forces of the valve body 12. Said retainer 11 facilitates mounting of the switching control device 1 and it can be arranged and fastened to the base body 4 in such a way that the second shell 3 does not have to absorb any forces from the control valve 6.

Seals can be provided between the shells 2, 3 and the base body 4 in order to seal the two inside spaces against each other and especially against the ambient environment.

The base body 4 accommodates a first electric connection 8 and a second electric connection 9 which are connected in an electrically conductive manner with the electronic component 5. For example, the first electric connection 8 is used for connecting the electronic component 5 with a vehicle control device or the vehicle control system, e.g. by way of a CAN bus. The second electric connection 9 can form an electric interface for components associated with the retarder, e.g. sensors and/or actuators, especially a temperature sensor and a pressure sensor. It is understood that is also possible to provide only one electric connection or a larger number of electric connections, with the illustrated electric connections 8, 9 already respectively having a plurality of electric contacts.

A plurality of connections for compressed-airlines is further provided in the base body 4. A first connection, which is the compressed-air input 20, is used for connecting a compressed-air supply, and two further connections, which are the compressed-air output 21, are used for discharging an actuating air pressure controlled by the switch and control device 1. The compressed air which is supplied by way of the compressed-air input 20 to the switch and control device 1 is guided through the control valves 6 which form respective valve control edges especially by co-operation of the valve body 12 with the base body 4 and transmit the supplied compressed air in the compressed-air outputs 21, with the air pressure at the compressed-air outputs 21 varying depending on the position of the control valves 6. One example for a respective control with the three control valves 6 will be described below by reference to FIG. 3.

Furthermore, a third compressed-air connection, which is an exhaust-air connection 13, is provided, by means of which the control valve 6, at least two of the three control valves 6, and the air-conducting spaces can be evacuated when the compressed-air input 20 is blocked off by means of one of the three control valves 6. In the present case the exhaust-air connection 13 is arranged in the second shell 3.

A pressure sensor 7, especially in the form of an electropneumatic pressure sensor, is provided on the electronic component 5, which in this case is arranged in the form of an electronic circuit board. In contrast to all other pneumatic components which are arranged exclusively in the interior space arranged between the second shell 3 and the base body 4, the pressure sensor 7 is arranged in the first interior space which is formed by the first shell 2 and the base body 4. The base body 4 therefore advantageously forms a compressed-air conducting connection between the pressure sensor 7 and the control valves 6 or a further compressed-air interface (not shown) for supplying an external air pressure which is to be detected by means of the pressure sensor 7. Similarly, one or several further compressed-air connections (not shown) can be provided in order to discharge compressed air from the switch and control device 1 and/or to supply it to the same.

FIG. 3 shows a schematic illustration of the switch and control device 1. It shows the electronic component 5, the control valves 6 and various inputs and outputs.

The electronic component 5 comprises a controller 17 for switching the control valves 6 and for evaluating or further processing the pneumatic pressure absorbed by the pressure sensor 7. The pressure sensor 7 is arranged as an electropneumatic pressure sensor.

Furthermore, a number of electric interfaces are provided, which are the voltage supply 14, the data interface 15 which especially cooperates with a CAN bus, and the sensor-actuator interface 16. The voltage supply 14 and the data interface 15 are combined for example into the common electric connection 8 in FIG. 2, whereas the electric connection 9 is used for connecting the sensor-actuator interface with external components.

The controller 17 can also trigger the control valve 6 depending on the signals on the data interface 15 and the sensor-actuator interface 16 and supply the same with the voltage of the voltage supply 14.

As is shown in the drawing, the first control valve 6 (at the bottom in FIG. 3) is used for optionally supplying or blocking compressed air from the compressed-air supply and is therefore directly arranged behind the compressed-air input 20. In the illustrated embodiment this control valve 6 is further used to vent the switch and control device 1 or its areas conducting the compressed air when it closes off the compressed-air input 20. Accordingly, this control valve 6 comprises an exhaust-air connection 13.

The second control valve 6 which is arranged as a 2/2 directional control valve is disposed in the direction of flow of the compressed air (when the compressed-air input 20 is activated) behind the first control valve 6 which is arranged as a 3/2 directional control valve. It is used for the adjustment of a desired air pressure at the compressed-air output 21 which is arranged behind the second control valve 6 in the direction of flow of the compressed air. The second control valve 6 therefore has a control function in order to set the air pressure in a variable fashion over a predetermined range and is arranged as a proportional valve for example, whereas it is sufficient if the first control valve is arranged as an on-off valve or changeover valve.

The third control valve 6 (which is at the top in FIG. 3) acts as an exhaust valve and releases a flow cross section to an exhaust-air connection 13 whenever the compressed-air input 20 is closed off by the first control valve 6 in order to vent the switch and control device 1. Accordingly, the third control valve 6 can be arranged as a 2/2 directional control valve and can be opened in the unpowered state and closed in the powered state, whereas the second control valve 6 is advantageously opened in the powered state and closed in the unpowered state.

An additional output connection 35 for compressed air is connected to the compressed-air conduit between the first control valve 6 and the second control valve 6 in order to additionally enable the provision of compressed air from the compressed-air supply to other components outside of the switch and control device 1.

As is shown in FIG. 3, the pressure sensor 7 detects the air pressure (actuating pressure) which is applied to the compressed-air output 21. As already explained above, a further connection could be provided by way of which compressed air can be guided to the pressure sensor 7 so that the pressure sensor 7 will detect the pressure in this compressed air.

### LIST OF REFERENCE NUMERALS

1 Switch and control device
2 First shell
3 Second shell
4 Base body
5 Electronic component
6 Control valve
7 Pressure sensor
8 First electrical connection
9 Second electrical connection
10 Magnetic coils
11 Retainer
12 Valve body
13 Exhaust-air connection
14 Voltage supply
15 Data interface
16 Sensor-actuator interface
17 Controller
18 Cooling medium circuit
19 Hydrodynamic machine
20 Compressed-air input
21 Compressed-air output
22 Vehicle drive motor
23 Thermostat
24 Heat exchanger
25 Compensating reservoir
26 Transmission
27 Circulating pump
28 Primary wheel
29 Secondary wheel
30 Compressed-air container
31 Wheels
32 Housing
33 Retarder control valve
34 Retarder switching valve
35 Additional output connection

1-10. (canceled)

11. A switch and control device for setting the power or torque transmission in a hydrodynamic machine, comprising at least one primary wheel and a secondary wheel which together form a working space that can be filled with a working medium;
housing which is joined from a base body and two shells;
at least one electronic component which is used at least indirectly for controlling and/or monitoring the hydrodynamic machine or a predetermined state in the same;
at least one control valve which can be actuated by the electronic component in order to control a working medium flow in the hydrodynamic machine or into or out of the hydrodynamic machine;
characterized by the following features:
the first shell encloses the electronic component;
the second shell accommodates at least a part of the at least one control valve;
the two shells are arranged on face sides of the base body which face away from each other;
the first shell and/or the base body is/are arranged on the hydrodynamic machine or on a conduit guiding the working medium flow into or out of the hydrodynamic machine in such a way that heat transmission occurs between the working medium and/or the hydrodynamic machine on the one hand and the electronic component on the other hand.

12. The switch and control device according to claim 11, characterized in that the first shell faces away from the second shell and the ambient air flows around the second shell in such a way that heat from the control valve is removed convectively to the ambient environment.

13. The switch and control device according to claim 11, characterized in that the first shell and/or the base body is/are arranged to be thermally conductive with respect to each other and/or with respect to the hydrodynamic machine or the conduit conducting the working medium flow.

14. The switch and control device according to claim 12, characterized in that the first shell and/or the base body is/are arranged to be thermally conductive with respect to each other and/or with respect to the hydrodynamic machine or the conduit conducting the working medium flow.

15. The switch and control device according to claim 11, characterized in that the interior spaces formed by the base body and the shells are thermally insulated against each other and/or are sealed in a pressure-tight manner against each other.

16. The switch and control device according to claim 12, characterized in that the interior spaces formed by the base body and the shells are thermally insulated against each other and/or are sealed in a pressure-tight manner against each other.

17. The switch and control device according to claim 11, characterized in that the housing and especially the first shell are mounted on the hydrodynamic machine or on the conduit in such a way that the housing is insulated against vibrations of the hydrodynamic machine or the conduit.

18. The switch and control device according to claim 12, characterized in that the housing and especially the first shell are mounted on the hydrodynamic machine or on the conduit in such a way that the housing is insulated against vibrations of the hydrodynamic machine or the conduit.

19. The switch and control device according to claim 13, characterized in that the housing and especially the first shell are mounted on the hydrodynamic machine or on the conduit in such a way that the housing is insulated against vibrations of the hydrodynamic machine or the conduit.

20. The switch and control device according to claim 14, characterized in that the housing and especially the first shell are mounted on the hydrodynamic machine or on the conduit in such a way that the housing is insulated against vibrations of the hydrodynamic machine or the conduit.

21. The switch and control device according to claim 15, characterized in that the housing and especially the first shell are mounted on the hydrodynamic machine or on the conduit in such a way that the housing is insulated against vibrations of the hydrodynamic machine or the conduit.

22. The switch and control device according to claim 16, characterized in that the housing and especially the first shell are mounted on the hydrodynamic machine or on the conduit in such a way that the housing is insulated against vibrations of the hydrodynamic machine or the conduit.

23. The switch and control device according to claim 11, characterized in that the control device is a pneumatic valve, especially one that can be actuated electrically or electromagnetically.

24. The switch and control device according to claim 12, characterized in that the control device is a pneumatic valve, especially one that can be actuated electrically or electromagnetically.

25. The switch and control device according to claim 13, characterized in that the control device is a pneumatic valve, especially one that can be actuated electrically or electromagnetically.

26. The switch and control device according to claim 14, characterized in that the control device is a pneumatic valve, especially one that can be actuated electrically or electromagnetically.

27. The switch and control device according claim 11, characterized in that the housing and especially the base body comprises electric connections which are connected in an electrically conductive manner with the electronic component.

28. The switch and control device according to claim 11, characterized in that the housing and especially the base body comprises connections for compressed-air conduits which are connected with the at least one control valve in a manner conducting the compressed air in such a way that the at least one control valve can be supplied with compressed air from a compressed-air supply and variably sets a compressed-air actuating pressure on one of the connections in a manner controlled by the electronic component.

29. The switch and control device according to claim 28, characterized in that a pressure sensor is provided within the housing and especially on the electronic component, which pressure sensor detects the actuating pressure set by the at least one control valve, with an additional compressed-air input especially additionally being provided which is connected with the pressure sensor in such a way that the pressure sensor detects the pressure in the additional compressed-air input.

30. A drive train with a hydrodynamic machine, comprising at least one primary wheel and a secondary wheel which jointly form a working space which can be filled with a working medium;
a cooling medium circuit with a fluid or gaseous cooling medium is provided in order to cool at least indirectly the hydrodynamic machine and/or the working medium of the same;
characterized in that:
a control unit according to claim 11 is provided for setting the power or torque transmission in the hydrodynamic machine.
